(19) United States
(12) Patent Application Publication
(10) Pub. No.: US 2007/0158452 A1
(43) Pub. Date: Jul. 12, 2007

(54) Tropical hurricane storm control system

(76) Inventors: Eugene J. Hofffmann, Sun City, FL (US); David Lund, Hertford, NC (US)

Correspondence Address: EUGENE J. HOFFMANN, 1220 FAIRWAY GREENS DRIVE, SUN CITY, FL, 33573, US

(21) Appl. No.: 11/401,804

(22) Filed: Apr. 11, 2006

Related U.S. Application Data
(60) Provisional application No. 60/756,669, filed on Jan. 6, 2006.

(51) Int. Cl. A01G 15/00

(52) U.S. Cl. 239/14.1; 239/2.1

(57) ABSTRACT

The invention turns a hurricane/tropical cyclone into a tropical rainstorm by spraying a super coolant such as liquid oxygen, or liquid hydrogen, or liquid nitrogen, or other super cold liquid gas around the top of the eye wall and additionally if needed, into the front of the eye wall using aircraft with pre-measured amounts of super coolant. Based on actual results, a real time computer system will be developed to enable communications between aircraft and control the amount of super coolant dispersed. The result of the invention will reduce/eliminate the damage to life and property due to high winds and storm surge as well as the staggering costs for rebuilding.

### BACKGROUND OF THE INVENTION AND PRIOR ART

### References Cited (Referenced By)

### U.S. Patent Documents

| | | | |
|---|---|---|---|
| 2550324 | April 1951 | Brandau | 239/2 |
| 2903188 | September 1959 | Hutchinson | 239/2 |
| 3127107 | March 1964 | Merryweather | 239/2 |
| 3534906 | October 1970 | Gensler | 239/2 |
| 3896993 | July 1975 | Serpolay | 239/2 |

### OTHER REFERENCES

“Project STORMFURY—experiments and Outlook” by Helmut K Weickmann, NOAA Technical Memorandum ERL APCL-21, December 1978.
“Tropical Cyclone Modification: The Project Storm Fury Hypothesis” by Robert C. Sheets, NOAA Technical Report ERL 414-AOML30, August 1981
“Storm fury and the Hurricane Hunt” Ocean Industry, September 1968, vol. 3#9, pp 66-68.
“How to subdue a Hurricane”, Science News, Aug. 21, 1971, vol. 100, pp 128 and 129.
“Seeding Storms Fury's Ginger: Nothing definitive”, Science News, Jan. 15, 1972, vol. 101, p. 38.
“Physical basis of limit calculations”, by Kerry Emanuel, Set. 16, 1996
“Jdorje/Energy”, from Wikipedia, Oct. 20, 2005

### BACKGROUND OF THE INVENTION

1. Field of Invention

The purpose of the procedure is to control and minimize the threat of tropical cyclones, which have been increasing in quantity and intensity in recent years. It is our belief that global warming is playing an increasing role in this situation. Without a solution to counteract these tropical cyclones, they can continue to increase in intensity causing even greater loss of life, storm damage, and negative effect on our economy. There have been very limited attempts to control tropical cyclones in the past and success has been limited due to the agents used. We believe that our solution is vastly superior to prior solutions.

The method, the introduction of a super coolant such as liquid oxygen, or liquid hydrogen, or liquid nitrogen can disrupt and cause a tropical cyclone to diminish in intensity and become a rainstorm; break the eye wall, or implode by spraying a super coolant to the top and front of the eye wall, which will lower temperatures, create ice and ice water.

The super coolant can either be sprayed or dropped from one or more aircraft from above the top of the tropical cyclone eye wall.

It is necessary to control the amount of super coolant dispensed. This can be done either from a spray in a pre-measured container or other pre-measured containers, which could be dropped from the aircraft from above the eye wall. This would insure that the super coolant reaches it's target and that there is minimal risk to the aircraft and the crew. Once the container is in the eye wall, the contents can be dispersed either by electrically opening the container at both ends, or some other method. This makes the task of dispensing easy and if multiple aircraft are necessary, the amount dispensed can be controlled and coordinated. The amount of super coolant that would be used would vary according to the size of the tropical cyclone eye wall and the desired effect. Other factors would be wind speed, temperature, barometric pressure, and other factors that help make up a tropical cyclone. In order to determine how much super coolant to disperse, based on estimates and actual results, a real-time computer system and its program must take in all the pertinent data and determine how much super coolant to use, and when to do it. The rate at which the tropical cyclone is rotating, the rate that the super coolant is fed into the upper portions of the eye wall, and the speed at which maximum disruption occurs will determine when the computer determines to start dumping the super coolant. The real-time computer system will measure the amount of super coolant that is dispersed, stop the dispersion when the correct amount is reached, and inform the operator that the dispersion is completed. As soon as super coolant is added, the tropical cyclone disruption begins. The more super coolant that is introduced, the greater the effect will be and the longer it will last. Based on calculations and actual data, the computer program will be designed for optimum effect. That is why the computer system is needed to make this determination.

The barometric pressure in the eye is the most accurate way to determine the strength of a tropical cyclone.

During previous testing procedures, the tropical cyclone would re-intensify if the ideal conditions remained over water. Should this happen and the tropical cyclone still be heading toward land and populated areas, the procedure to control and diminish the tropical cyclone would be repeated. It could also be performed just before hitting land if deemed necessary. Once over land, the tropical cyclone would not have the fuel source of the hot moist air that it receives from the ocean. At this point, the tropical cyclone will continue to diminish in intensity and ultimately die out.

2. Description of the Prior Art

The invention related to tropical cyclones is Leonard H. Hutchinson's patent U.S. Pat. No. 0,290,3188 in 1959. He suggests preventing the development of a tropical cyclone by seeding the beginning composition with nucleating chemicals before the storm develops. With his procedure, he hopes to exhaust every weather pattern that might develop into a tropical cyclone. Our invention uses a different and much better agent to control and reduce tropical cyclones on a selective basis. Should they reform again over water and become a threat again, they will be hit again.

Another method of seeding mature tropical cyclones was used by Project Stormfury (see Other References above). They attempted to seed the super cooled water in hurricanes. Silver Iodide was applied to clouds from the eye wall outward in a straight line. With this procedure, they expected to create a new eye wall. This eye wall would be farther outward than the present eye wall. The new eye wall would feed off the previous eye wall. The aim of the project was to lessen the fury of the winds in mature tropical cyclones. Our invention reduces the intensity, wind speed, and the power of the eye wall, turning it into a tropical rainstorm.

With our invention, the possibility of a tropical cyclone changing direction is minimized as we are reducing its intensity and eye wall to that of a tropical rainstorm being moved by prevailing winds.

Another technique in seeding with Silver Iodide involves applying the Silver Iodide into the eye wall to develop condensation of water vapor releasing latent heat. It was hoped that this latent heat would offset pressure variance of the eye. After years of attempts with Silver Iodide, it was finally discovered that there wasn't enough water in the eye wall to fully utilize the potential of Silver Iodide. At that point the project was cancelled. Our invention lessens this pressure variance by reducing the temperature at the top, bottom and middle of the eye wall, preventing the eye wall from growing and expanding.

### SUMMARY OF THE INVENTION

Our invention controls, diminishes, and eliminates the monstrous forces of tropical cyclones. Intense wind speeds and enormous storm surges would be prevented. With the use of super coolants applied in a controlled manner, using a real-time computer system, which takes in all of the important variables and decides when and how much agent to dispense, the tropical cyclone is significantly reduced or imploded. By using pre-measured amounts of super coolant in containers, it is easier to control and disperse the super coolant and minimize any danger to the aircraft and their crews. The spraying of a super coolant can cause the tropical cyclone to return to normal weather or cause it to implode. This lessens pressure variances, slows wind speeds, and reduces storm surges.

### OBJECTS OF THE INVENTION

The object of our invention is to control, diminish, and eliminate the strong winds and heavy storm surge created by the eye wall in tropical cyclones.

Each year, this will save thousands of lives, up to a $trillion for damage repair and living expenses for those effected.

Because the super coolants are environmentally friendly, there are no negative environmental issues.

Only tropical cyclones deemed by the National Hurricane Center as dangerous to land and their population will be targeted treatment.

By controlling the strong winds and heavy storm surge created by the eye wall, the other positive effects of the rainstorm can be used beneficially for crops and water supplies, etc.

Other objects, advantages, and novel features of the invention will become apparent from the following description of the invention when considered in conjunction with the accompanying drawings.

### BRIEF DESCRIPTION OF THE DRAWINGS

For a complete detailed description of the illustrations, reference should be made to the detailed descriptions below.

FIG. 1 is a side view of a tropical cyclone vertically dissected through the eye.

FIG. 2 is a side view of a tropical cyclone vertically dissected through the eye after treatment. The tropical cyclone is now a tropical rainstorm.

FIG. 3 is a top view of a tropical cyclone.

FIG. 4 is a top view of a tropical cyclone after treatment.

FIG. 5 is a side view of a tropical cyclone during super coolant treatment to the top of the eye wall.

FIG. 6 is a side view of a tropical cyclone during super coolant treatment to the front of the eye wall.

In all the illustrations the numerals depict the same objects.
1 represents the eye of the tropical cyclone.
2 represents the spiral bands.
3 represents the counter-clockwise motion of the tropical cyclone.
4 represents the eye wall of a tropical cyclone.
5 represents the rising warm air.
6 represents the storm surges within the eye.

### DETAILED DESCRIPTION OF ILLUSTRATIONS

All the illustrations are not to scale and have been exaggerated at points for clarity.

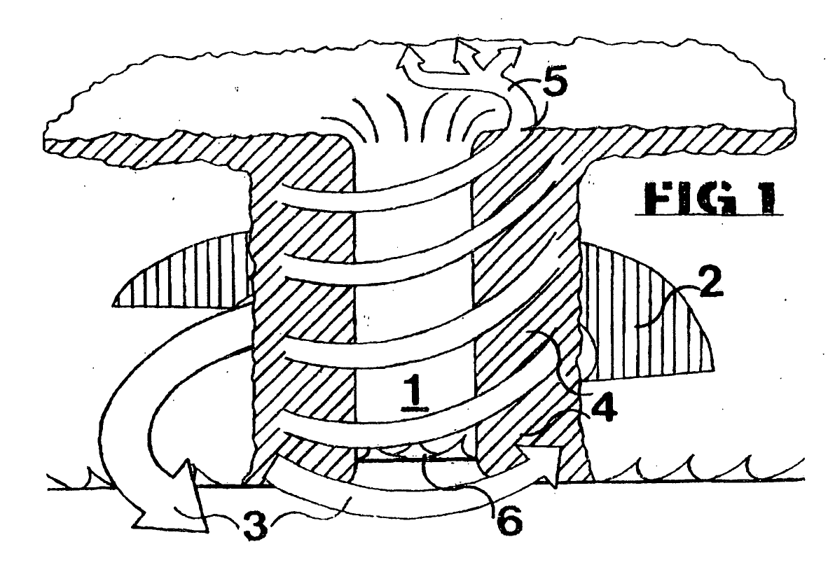

In reference to FIG. 1, each numeral represents the individual part of the tropical cyclone. The numeral 1 represents the eye of the tropical cyclone. Here the pressure is extremely lower than that of the surrounding pressure. Throughout the rest of the tropical cyclone the air pressure is much higher.

In FIG. 1, the numeral 2 represents the spiral bands of rain clouds. There are multiple layers of spiral bands rotating with the tropical cyclone. The layers will alternate with bands of cold air and hot air.

In FIG. 1, the numeral 3 designates the direction of the wind within the tropical cyclone. Tropical cyclones that develop in the Northern Hemisphere rotate in a counterclockwise direction.

In FIG. 1, the numeral 4 represents the eye wall of a tropical cyclone. The eye wall possesses the most destructive wind forces of the tropical cyclone. This is the place where the super coolant would be administered into the upper layers.

In FIG. 1, the numeral 5 represents the rising warm air. As the air reaches the top of a tropical cyclone, it is carried away by horizontal upper atmosphere winds. The winds flow above the tropical cyclone.

In FIG. 1, the numeral 6 represents the storm surges within the eye of the tropical cyclone. These surges can raise the water level inside the eye by 25 feet. As a tropical cyclone hits land, the storm surge accounts for the majority of the flooding and deaths associated with mature tropical cyclones.

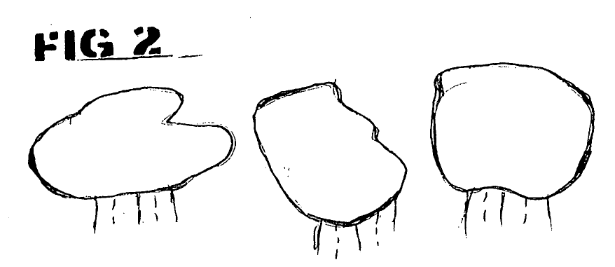

FIG. 2 illustrates a tropical cyclone after being treated. The tropical cyclone has been reduced to a tropical rainstorm and air pressure has also been increased. The wind direction will most likely not change and be driven by the prevailing winds.

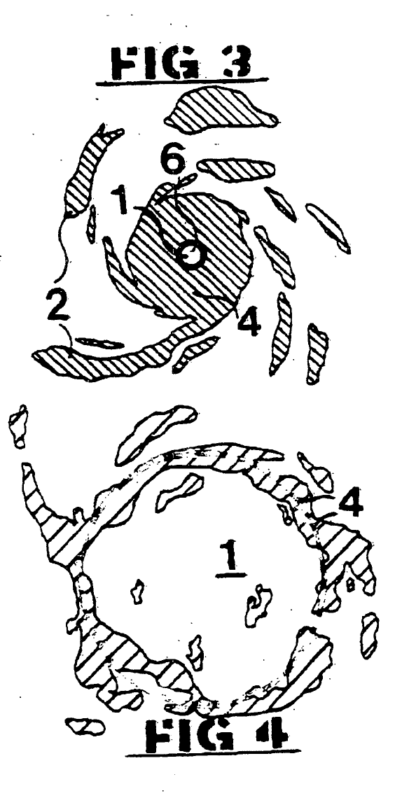

FIG. 3 illustrates an average mature tropical cyclone from above. The numeral 1 represents the eye. The numeral 2 represents the spiral bands emanating from the tropical cyclone. The numeral 4 represents the eye wall. The numeral 6 represents the storm surges.

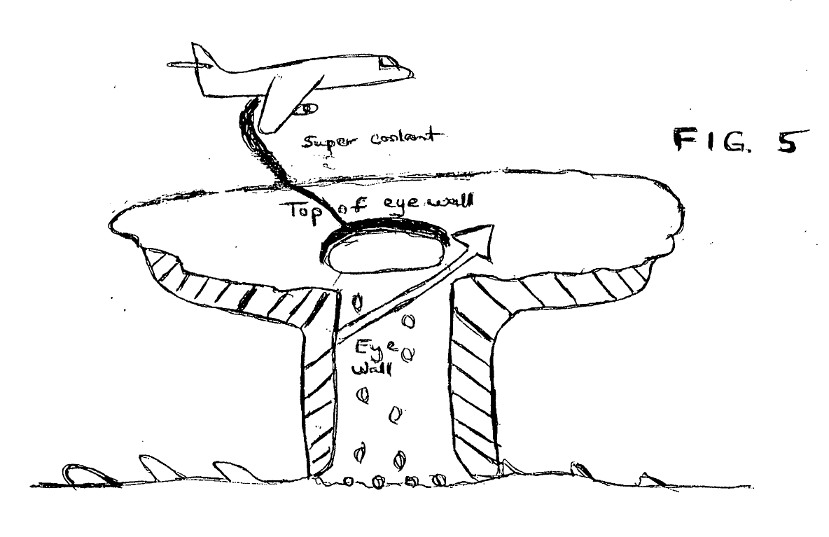

FIG. 4 illustrates a tropical cyclone from above after treatment. The numeral 1 represents no eye. The numeral 4 represents the broken eye wall. The spiral bands are no longer defined. The storm surge is not a factor anymore.

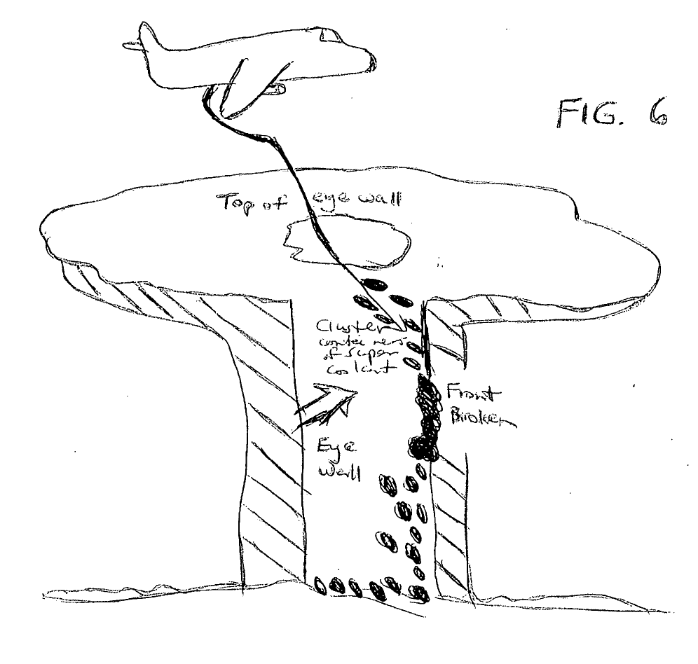

FIG. 5 illustrates a tropical cyclone with a plane dispensing a super coolant to the top of the cyclone to reduce the cloud temperatures and water vapor. This will have the effect of making it a normal storm, not a cyclone.

FIG. 6 illustrates a tropical cyclone with a plane dispensing a super coolant to the front of the eye wall through the top of the eye wall to break up the eye wall where the super coolant strikes. This should break up the eye wall by freezing the warm moist air, turning it to ice crystals, which should land in the water below, reducing the surface temperature and the ability of the cyclone to continue feeding warm moist air upward.

### BRIEF DESCRIPTION OF THE PREFERRED EMBODIMENTS

Our invention controls, diminishes, and eliminates the monstrous for of winds and storm surge created by the eye wall of tropical cyclones. This will prevent or significantly reduce the serious loss of life, damage to structures, and huge expenses to repair all of the damage caused. This will be done with the use of a super coolant (liquid nitrogen is preferred), to reduce the temperatures at the top of the eye wall, the middle, and the bottom. The eye wall needs warm moist air to grow in size and intensity. The super coolant will be sprayed or dropped for two aircraft flying over the eye wall of the tropical cyclone. The super coolant will be stored in pre-measured vessels to control the quantity dispersed. As a result of actual use, a real-time computer system will be developed to provide optimum dispersion and communications between the aircraft.

### DETAILED DESCRIPTION OF THE INVENTION

Scientists believe that tropical storms are formed when the air aloft (5-10 km) is sinking, due to the presence of a subtropical high (a semi-permanent system) that facilitates sinking air motions. The sinking air warms and creates a temperature inversion (an extremely stable air layer in which the temperature increases with altitude, the inverse of the usual temperature profile in the lower atmosphere. Air pressures near the top of the storm, in response to the latent heat warming, begin to rise. In response to higher pressure aloft, air begins to flow outward around the top of the center of the cyclone. Once the cyclone/hurricane effect is started, more warm air and moisture are drawn aloft from warm surface water temperatures, increasing the intensity.

The object of this patent is to provide solutions which: control the cyclones intensity before it becomes a significant event; reduce the temperatures at the top of the eye wall and at the bottom by the waters surface to reduce it from a cyclone to a rain storm; and to crack the forward portion of the eye wall of the cyclone using a super coolant to reduce temperatures thereby causing the cyclone to implode. By reducing the temperatures, the available energy for vibrating, translating and rotating atoms and molecules is also diminished. If it were possible to stop all molecular motions, the temperature would be what scientists call absolute zero or −459.67 degrees Fahrenheit. The temperature of liquid nitrogen is about 70% of that, and is still extremely cold. When very high water content is subjected to liquid nitrogen, millions of tiny ice crystals are formed. These crystals are not very well attached to one another because they each started growing at different spots and were not well aligned. These are called grain boundaries. The presence of many weak grain boundaries makes it easy to shatter the resultant ice. The result of this patent will be a reduction in barometric pressure, wind, and storm surge.

Each solution listed above will utilize a super coolant such as liquid oxygen (−362 degrees Fahrenheit), liquid hydrogen (−434 degrees Fahrenheit), or liquid nitrogen (−321 degrees Fahrenheit). Liquid hydrogen is significantly the coolest, but it is potentially flammable. Liquid oxygen is also potentially flammable. Prior to actual testing to prove which super coolant is going to be the preferred one, we believe that liquid nitrogen should be the best. The reasons we believe that liquid nitrogen is best is because it is the least expensive, can be stored in a vacuum insulated vessel for several days, has the best cooling power, and won't expand explosively. Liquid nitrogen is the same density as water, which makes it fairly heavy. There is a need for adequate ventilation (oxygen levels are maintained at 20.8% concentration during normal storage and handling) in the aircraft to maintain balance. Should there be an inadvertent release of liquid nitrogen, sufficient space is necessary depending on the size of the vessel.

The aircraft which should be considered for the task of carrying liquid nitrogen is the C-5 Galaxy. This is due to its payload size, ability to load and unload, extended range, and a system that records and analyzes malfunctions in more than 800 test points.

Because of the extreme cold and high expansion characteristics of liquid nitrogen, some additional features should be considered for the aircraft:

A completely sealed crew cabin including the entry/exit door.

A bathroom facility with drinking water within the crew cabin.

An ejection system for the crew in the event of a serious event. Since this is a sea, it would be advisable if the entire cabin area could be ejected and capable of flotation until rescue. There should also be a location beacon and communications.

A powerful venting system in the storage portion of the aircraft. The purpose would be to evacuate the liquid nitrogen in the vent of a leak. An additional option would be to disperse the super coolant while the aircraft is in the air.

A Monitoring and Internal and External Alarm Subsystem. In the event of a leak of a super coolant within the aircraft, there will be both an Internal and External alarm. Both will be manually activated and deactivated. Both will have an alarm and flashing light. There will be a number of test points within the aircraft to monitor for a leak. There is a need for an oxygen depletion monitor and a cabin alarm stating “Do not enter while alarm is sounding”.

There may be a need for one or two additional aircraft above the two, which would normally fly together in the event of problem causing the crew to eject. This would be for future flights during the hurricane season. There might also be a need for an air/sea rescue aircraft to pick up the ejected cabin and crew.

Care must also be taken when transporting the vessel from one location to another and it should be in one step. In order to spray the super coolant, there needs to be multiple insulated stainless steel tube extending through the skin of the aircraft for each vessel, most likely underneath the aircraft, to dispense the super coolant. Each tube needs to extend far enough from the aircraft body to prevent any damage to the controls of the aircraft. The amount of super coolant sprayed can be adjusted by increasing the pressure inside the storage tank or the number of tubes. Each tube will be connected to a cryogenic valve, which is attached to the vessel containing the liquid nitrogen. This can be done through an electrical interface. The actual dispersion will be controlled electrically through the use of a solenoid and monitoring device to determine when to start and stop the dispersion.

Liquid nitrogen has a heat vaporization rating of 160 Joules per cubic centimeter, which is a good rating. Another way to describe this is it takes 155 BTU to boil off a liter. This can be the heat it takes out of the cyclone area adjacent to each liter of liquid nitrogen. Further, 1 liter of liquid nitrogen expands to 682 liters when it vaporizes to the outside temperature. There is a different expansion factor when it still stays extremely cold for our purposes. This may significantly reduce the need for as much super coolant when actual testing is performed. For the initial testing, it is recommended that a series of smaller vessels (about 40,000 liters) be used until enough data is collected to determine an optimum size vessel. Liquid nitrogen will dispense into the atmosphere without any environmental issues. The super coolant will be stored in one of more jet aircraft and dispersed using a spraying method.

The result of this solution is that the final result is H2O (water), so there is no environmental impact.

The best way to control the cyclones intensity, before it becomes a significant event, is to hit it early once the eye wall forms. This does not mean that every cyclone that forms needs to be hit. Location and direction of the storm will be part of the decision process. Those cyclones, which appear to be heading toward populated areas such as the Caribbean Islands, The United States, and Mexico will be targeted. Depending on the aircraft size, amount of super coolant needed, departure location of the aircraft (probably Florida or Puerto Rico), and the distance to and from the target cyclone, it is possible that aerial refueling may be required in some instances. Once the cyclone is brought to a very low level/reduced to a rainstorm, it will be monitored for reforming into a cyclone again. If this happens, again a decision will be made as to whether or not it will be a threat to populated areas. If yes it will be hit again, etc. The objective is to not eliminate the rain, which can be needed by the locations that the storm goes to, but to mitigate/eliminate the high winds and heavy storm surge created by the eye wall, which cause severe damage and loss of life.

To reduce the temperatures at the top of the eye wall and at the bottom, a super coolant would be sprayed around the top of the eye wall using one or more jet aircraft.

The super coolant would be stored in vacuum insulated vessels inside the aircraft to maintain the cold temperatures until dispersion. An alternative method of dispersion could be with pre-measured containers, which could be dropped like cluster bombs and then opened. The downside of this method is retrieval of the containers, which should float. Until actual tests on live hurricanes are performed and results are recorded, it is difficult to accurately estimate exactly how much super coolant is necessary. Variables include: the width of the eye wall, width at the top of the eye wall that needs to be sprayed for maximum effect, depth of coolant sprayed for optimum effect both near the top and at the bottom of the eye wall, temperatures at the top and bottom of the eye wall, water temperatures, speed of the storm, and possibly intensity (which should be minimal when hit early). Since liquid nitrogen expands up to 682 times when released and turns to a gaseous state, we are using 100 times for these calculations taking into account cooling temperatures. The following are some preliminary calculations based on two different eye wall width assumptions, which appear to be linear in nature:

½ mile wide eye wall, super coolant spread 200 ft. from the eye wall edge back, 2 inches deep.

2640 ft.×3.1417 for perimeter×200 ft. wide×⅙th ft. deep× 1/100 for expansion=2765 cubic ft. super coolant.

1-mile wide eve wall, super coolant spread 200 ft. from the eye wall edge back, 2 inches deep.

5280 ft.×3.1417 for perimeter×200 ft. wide×⅙th ft. deep× 1/100 for expansion=5530 cubic ft. super coolant.

To convert cubic ft. to liters, one must multiply a cubic ft. by 28.32 to obtain the number of liters. In the above calculations for a ½ mile wide eye wall, it is 2 765×28.32=78,305 liters and for a 1-mile wide eye wall, it is 5530×28.32=156,610 liters. The actual amount of liquid nitrogen available in each vessel is actually 1726 liters more than the calculations.

Assuming that two aircraft are capable of carrying two vessels each, the following information is available on the Internet from Taylor-Wharton Cryogenics, 4075 Hamilton Blvd, Theodore, Ala. 36582, Ph: 800-898-2657, E-Mail: www.taylorwharton.com. The company makes a variety of vessels to handle liquid nitrogen. The following are examples of: Models, Gallon/Liter Capacity; Max. Working Pressure; Empty Weight, Filled Weight, Height (Ft-In), Diameter (Ft-In), Length (Ft-In). This provides some information as to what size and weight is necessary to carry the liquid nitrogen in each plane. Filled Weights are computed based on 1 gallon=8 lbs.

| Model | Gallons | Liters | Max Wk PSI | Empty Wt. | Filled Wt. | Height | Diameter | Length |
|---|---|---|---|---|---|---|---|---|
| 11,000 | 10,800 | 40,878 | 250 | 46,000 lb. | 132,400 lb. | 11′ 8″ | 10′ 9″ | 29′ 11″ |

Assuming each aircraft can carry two vessels, the above numbers would double per aircraft and two aircraft could handle the anticipated need. Due to the size of the vessels vs. the width of the aircraft, they will probably have to be mounted lengthwise in the aircraft. Each vessel would need multiple insulated stainless steel tube connected to cryogenic valves for dispersion and dispersion from each vessel would be simultaneous to prevent any imbalance to the aircraft. If it is decided to mount the vessels widthwise, then more smaller vessels and additional insulated stainless steel tubes would be needed. Assuming that the hurricane eye wall is spinning at around 70 mph, it would only take under 2 minutes to circulate the liquid nitrogen around the top of the eye wall. This means that the liquid nitrogen has to be dispensed quickly. This will determine the number and diameter size of the insulated stainless steel tubes and the dispersion rate. To further optimize the speed of dispersion, each aircraft could dispense it's super coolant at a 180 degree distance from the other aircraft. This should provide some information as to the size and type of aircraft necessary for the task.

The above calculations are for an eye wall of up to one mile wide. In the event that the eye wall is wider or it is chosen to go after a larger eye wall, then more aircraft and super coolant would be necessary to do the job. Assuming that the cooling of a larger eye wall would be linear, the following table would apply for larger eye walls:

| Eye Wall diameter in miles | # Aircraft needed with super coolant |
|---|---|
| 1½ | 3 |
| 2 | 4 |
| 2½ | 5 |
| 3 | 6 |
| 3½ | 7 |
| 4 | 8 |
| 4½ | 9 |
| 5 | 10 |

There is a formula for projecting the Kinetic Energy of the eye wall vs. the anti-energy of the liquid nitrogen. This was available on the internet at http://wikipedia.org/wik/User:Jdorje/Energy. The formula supports our calculations to some extent, but may not take into account all of the characteristics of liquid nitrogen and our solution. The formula is as follows:

For the Eye Wall of 1 mile diameter:
Ke=0.5mv2=0.5×(pi×r2×h×p×d)×v2
m is the mass of moving air
pi is 3.14
r is the radius of the hurricane in meters (1600 meters=I mile)
h is the height of the hurricane in meters. This is probably the height of the cloud tops.
p is the pressure of the hurricane. Over the entire volume (in % of sea level pressure)
d is the density of air, in kg/m3. This is 1.2
v is the velocity of the hurricane, over the entire volume (in meters/second: 3600 seconds=1 hr)
Applying the numbers to the formula:
Ke=0.5×(3.14×1600 squared×1000×.990×1.2)×75×1600
After completing the computation:
Ke=5,711,558,400,000joules
The negative joule energy from the liquid nitrogen is:
Ke=163,512×160×Number of cubic centimeters in a liter (1000)
After completing the computation:
Ke=261,619,200,000joules
This yields a ratio of 28.81 to 1 in favor of the hurricane.
By adding additional aircraft totals the ratio goes down:
Total 4 aircraft 10.92 to 1
Total 6 aircraft 7.28 to 1
Total 8 aircraft 5.45 to 1
Etc.

Until actual testing is done, it is not necessarily clear what ratio is necessary to take out the eye wall. There are other features in liquid nitrogen and the method of dispersion, which can improve the results vs. the formula.

Due to the size and weight of the vessels, consideration must be given to transporting and loading onto the aircraft as well as securing the vessels for flight. The other considerations are the number of vessels and the plumbing for dispersion. The fewer the number of vessels, the easier it is to manage the plumbing and placement. If more and smaller vessels are used to cut down the weight and size, then additional consideration must be given to securing and placement of the vessels as well as the additional weight of more vessels. It is strongly recommended that the supplier of the super coolant be involved in the implementation process. Another option might be to load the super coolant onto the aircraft on-site at a place like Cape Canaveral, which is used to handling this type of material This would minimize the transporting and loading requirements, since the super coolant could be stored on-site. Because of the length of the vessels, it is possible they may not be able to be placed sideways in the aircraft. If sideways mounting is Preferred, then a different size vessel will be needed. In either case, they need to dispense the liquid nitrogen quickly and simultaneously to maintain balance in the aircraft. By using Cape Canaveral, which has been dealing with super coolants as fuels for years in space shuttles, etc., we have an ideal location of proximity to hurricanes, technology and experience. It also provides another extremely important use of the facility. Since NOAA only monitors and reports on hurricanes, a new organization could be formed, based at Cape Canaveral, whose task is to control hurricanes. NOAA can still do its monitoring and reporting function and in addition would work with the new organization. Timing, readiness and coordination will be important to have maximum impact on hurricane control

Due to the centrifugal force nature of the cyclone eye wall, dispersion should be fairly easy. By dropping the super coolant in a given area by the eye wall edge, the eye wall should pull the super coolant around the entire perimeter. It is recommended that the aircraft fly clockwise since the eye wall rotates counter clockwise to speed the spraying process. To achieve relatively even dispersion, the super coolant needs to be dropped at a rate in keeping with the rotational spin. Since the super coolant is heavier than air, it is highly likely that the centrifugal force will bring much of the super coolant further down into the upper part of the eye wall, cooling that as well. The remainder of the super coolant, ice water, and ice lands in the water below. Since the eye wall pulls water and moisture from below as well, the coldest water, ice, and possibly some super coolant will be pulled back up from the surface area since it is closest to the eye wall, playing right into our plan to cool the lower portion of the eye wall as well.

An additional technique can be employed to crack the forward portion of the eye wall, which should break up the rotation of the cyclone, returning it to a tropical rainstorm.

By spraying the super coolant to the front of the eye wall from the top down, it will lower the temperature in that portion of the eye wall causing super coolant, ice and ice water to fall through the eye wall to the bottom. The risk in this technique is the centrifugal force of the eye wall, which could dissipate coolant before the desired effect. It may take more super coolant than doing the top as described above or a large amount in a concentrated area over a short period of time. Another variable with this technique is the height of the eye wall from top to bottom. In this technique again super coolant ice and ice water will land in the water surface below and pulled back up by the cyclone. As a result, the spinning action of the cyclone will be broken and the ability to move warm moist air aloft will be impaired, thereby causing the cyclone to implode. This can be done either by aerial spraying or by dropping pre-measured amounts in containers in a method like a cluster bomb. This method could be employed either at sea or before landfall since the cyclone will implode and have minimal chance to start up again. Again doing it at sea, while the cyclone is small, is easier than when it reaches its maximum size and velocity. However, by hitting the cyclone at sea one or more times, the size and power should be minimized.

Based on actual results from using the super coolant on various hurricanes, parameters will be developed with the above formulas to determine optimum usage for storms based on the storm parameters. This information will be incorporated in a computer program using a real-time computer system on the aircraft, which dispenses the super coolant in order to insure that the released super coolant is properly dispersed to the target and to minimize any potential danger to the aircraft from the tropical storm. The super coolant will be released by spraying or dropping pre-measured amounts in containers, which will be opened near the top of the cyclone or at the area at the front of eye wall. This could be done electrically or by some other method. Assuming multiple aircraft are used for the task, they would also have pre-measured containers and be able to communicate with each other as to how much more super coolant needs to be dispensed using the real-time computer system. All of the pertinent data regarding the storm are needed to determine how much super coolant is needed and when to drop it for maximum effect. These should be recorded as well as how much super coolant was used, technique, and results.

It will be further understood that the method of this invention is not to be limited to the precise form disclosed in the preferred embodiments, but may be modified without departing from the scope of the invention as defined in the appended claims.

1. The invention will use a super coolant such as liquid oxygen, liquid hydrogen, or liquid nitrogen, or other super cold liquid gas to reduce the temperatures at the top, middle, and bottom of a tropical cyclone, reducing the winds and storm surge of the eye wall, which will be converted into a tropical rainstorm.

2. Liquid nitrogen (−321 degrees Fahrenheit) appears to be the best super coolant choice due to lower cost, and lower likelihood of exploding.

3. The pre-measured super coolant would be loaded into pressurized and secured vessels onto two large aircraft, most likely a C5 Galaxy.

4. The vessels for storing the super coolant must be positioned within the cargo portion of the aircraft in such a way as to not imbalance the aircraft as the super coolant is dispersed.

5. The vessels are connected to stainless steel hoses for dispersion from the rear of the aircraft when the aircraft reaches the tropical cyclone.

6. The aircraft's crew cabin and exit door must be capable of being sealed from the extreme cold of the super coolant in the event of a leak.

7. In the event of an unexpected problem, which requires evacuation of the aircraft, the crew cabin must be capable of being jettisoned from the body of the aircraft and parachute to the water's surface.

8. The crew cabin must be able to float, have a bathroom, drinking water, tracking beacon, communications, and the ability to be separated electrically from the interfaces to the vessels containing the super coolant.

9. Based on inputs from the National Hurricane Center, which determines that the eye wall has formed in the tropical cyclone and it is a threat to land and populated areas, the aircraft are then loaded for the mission.

10. When the aircraft reaches the tropical cyclone, the diameter of the eye wall will be measured to determine the amount of super coolant to disperse according to the formulas in the Detailed Description.

11. The super coolant will then be dispersed around the top edge of the eye wall back and the tropical cyclone will assist in this process since it rotates counterclockwise.

12. A significant amount of super coolant will be placed around the top of the eye wall and down.

13. There will be a significant reduction in the temperature around the top of the eye wall converting it to a tropical rainstorm.

14. As a result of the super coolant, ice crystals and ice water will extend down through the eye wall and to the water surface below.

15. The tropical cyclone will attempt to pull warm water up from the surface, which is now ice crystals and ice water, further pulling very cold ice crystals and water into the bottom of the tropical cyclone.

16. An additional technique is to spray or drop the super into the forward portion of the eye wall, causing it to crack or break with similar results to the above.

17. Based on the results of a number of flights and results, information gathered will be put into a real-time computer system to make future flights easier as well as enabling communications between aircraft to control dispersion of the super coolant.

18. Once the task is completed, the aircraft return to base, awaiting further orders.

19. Should the tropical cyclone reform, it can be hit again, etc. as long as it is deemed a threat to land and population.

20. Catching a tropical cyclone early, makes the task easier of controlling the eye wall and its wind and storm surge before landfall.

21. The byproduct of the patent is H20, which is environmentally friendly.

22. The tropical rainstorm will follow the prevailing wind path to enable land areas in the path to receive needed rain, without the destructive winds and storm surge.
